(19) United States
(12) Patent Application Publication
(10) Pub. No.: US 2006/0038935 A1
(43) Pub. Date: Feb. 23, 2006

(54) Display apparatus

(76) Inventor: Jong-Oh Kim, Seoul (KR)

Correspondence Address: CANTOR COLBURN, LLP, 55 GRIFFIN ROAD SOUTH, BLOOMFIELD, CT, 06002, US

(21) Appl. No.: 11/185,512

(22) Filed: Jul. 20, 2005

(30) Foreign Application Priority Data
Aug. 18, 2004 (KR) 2004-65003

(51) Int. Cl. G02F 1/1335

(52) U.S. Cl. 349/64

(57) ABSTRACT

In a display apparatus, a display panel displays images using light, and a backlight assembly provides the display panel with the light. A brightness enhancement film between the display panel and the backlight assembly enhances a brightness of the light supplied to the display panel. A diffusing adhesive layer has an adhesive material and diffusing particles added into the adhesive material to diffuse the light having come out of the backlight assembly. Thus, the display apparatus may effectively prevent a Moiré interference and improve display quality thereof.

This application claims priority to Korean Patent Application No. 2004-65003 filed on Aug. 18, 2004 and all the benefits accruing therefrom under 35 U.S.C. §119. the contents of which are herein incorporated by reference in its entirety.

### BACKGROUND OF THE INVENTION

1. Field of the Invention

The present invention relates to a display apparatus. More particularly, the present invention relates to a display apparatus having improved display quality.

2. Description of the Related Art

In general, a liquid crystal display apparatus includes a liquid crystal display panel and a backlight assembly disposed under the liquid crystal display panel. The liquid crystal display panel displays images using light, and the backlight assembly generates the light to be provided to the display panel.

The liquid crystal display panel comprises a lower substrate, an upper substrate facing the lower substrate, and a liquid crystal layer disposed between the lower substrate and the upper substrate. The lower substrate is a substrate on which thin film transistors and pixel electrodes are arranged in a matrix shape. The upper substrate includes a common electrode formed at a position corresponding to the pixel electrodes.

The backlight assembly includes a lamp and a light guide plate. The lamp generates light and the light guide plate guides the light from the lamp to the liquid crystal display panel. The backlight assembly further includes a diffusion sheet, a first prism sheet and a second prism sheet. The diffusion sheet is disposed on the light guide plate to diffuse the light guided by the light guide plate. The first and second prism sheets are disposed on the diffusion sheet to collimate the diffused light.

The first prism sheet has prism patterns having a width substantially parallel to a widthwise direction of the liquid crystal display panel. The second prism sheet has prism patterns having a length substantially parallel to a longitudinal direction of the liquid crystal display panel. A plurality of rectangular areas are defined by crossing the prism patterns in the widthwise direction with the prism patterns in the longitudinal direction. The rectangular areas defined by the prism patterns of the prism sheets are disposed beneath the pixels of the lower substrate. As a result, a Moiré interference occurs on a screen of the liquid crystal display apparatus, thereby deteriorating display quality of the liquid crystal display apparatus.

### BRIEF SUMMARY OF THE INVENTION

The present invention provides a display apparatus having improved display quality.

In an exemplary embodiment, the display apparatus includes a display panel, a backlight assembly, a brightness enhancement film and a diffusing adhesive layer.

The backlight assembly is disposed under the display panel and generates a light to provide to the display panel. The display panel displays images by using the light supplied from the backlight assembly. The brightness enhancement film is disposed between the display panel and the backlight assembly to enhance brightness of the light supplied to the display panel. The diffusing adhesive layer has an adhesive material and a plurality of diffusing particles added into the adhesive material to diffuse the light.

In another exemplary embodiment, the display apparatus includes a display panel, a backlight assembly, a first polarizing plate, a second polarizing plate, a brightness enhancement film and a diffusing adhesive layer.

The display panel comprises a lower substrate, an upper substrate facing the lower substrate and a liquid crystal layer disposed between the lower substrate and the upper substrate to display an image using the light supplied from the backlight assembly. The first polarizing plate is disposed under the display panel to polarize the light supplied to the display panel and the second polarizing plate is disposed on the display panel to polarize the light passing through the display panel.

The brightness enhancement film is disposed between the backlight assembly and the first polarizing plate to enhance brightness of the light supplied to the first polarizing plate. The diffusing adhesive layer has an adhesive material to attach the brightness enhancement film to a surface of the first polarizing plate and diffusing particles added into the adhesive material to diffuse the light.

According to the display apparatus of the present invention, the diffusing adhesive layer and the brightness enhancement film are disposed between the backlight assembly and the display panel, so that the display apparatus effectively prevents Moiré interference thereof and improves the display quality thereof.

### BRIEF DESCRIPTION OF THE DRAWINGS

The objects, features and advantages of the present invention will become readily apparent by reference to the following detailed description when considered in conjunction with the accompanying drawings wherein:

FIG. 1 is a cross-sectional view showing a display apparatus according to an exemplary embodiment of the present invention;

FIG. 2 is an enlarged view showing portion “A” of FIG. 1;

FIG. 3 is a perspective view showing a brightness enhancement film of FIG. 1;

FIG. 4 is a cross-sectional view showing a first polarizing plate and a second polarizing plate of FIG. 1; and

FIG. 5 is a cross-sectional view showing a first polarizing plate and a second polarizing plate according to another exemplary embodiment of the present invention.

### DETAILED DESCRIPTION OF THE INVENTION

Hereinafter, the present invention will be explained in detail with reference to the accompanying drawings.

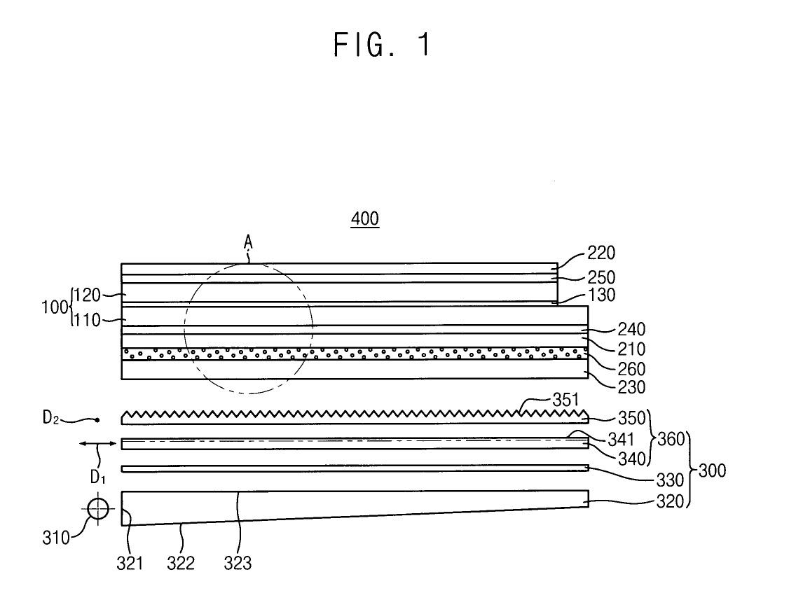

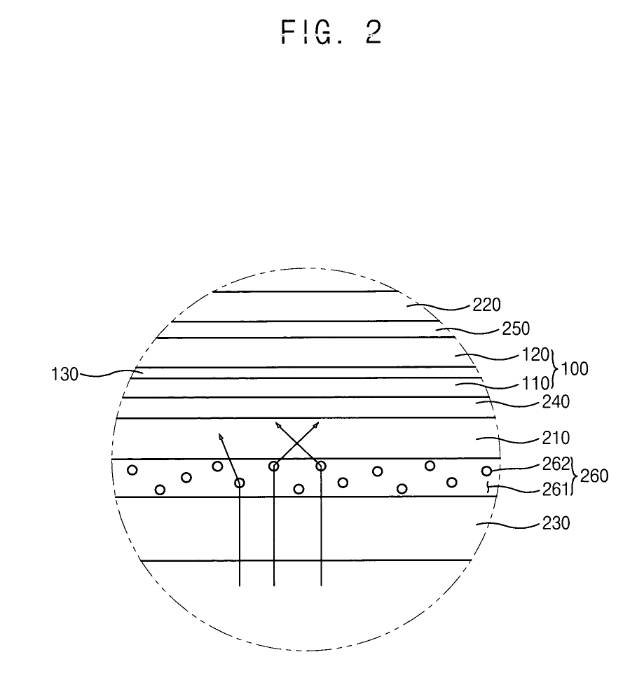

FIG. 1 is a cross-sectional view showing a display apparatus according to an exemplary embodiment of the present invention. FIG. 2 is an enlarged view showing portion “A” of FIG. 1.

Referring to FIG. 1, a display apparatus 400 according to an exemplary embodiment of the present invention includes a display panel 100 configured to display images. The display panel 100 comprises a lower substrate 110, an upper substrate 120 facing the lower substrate 110, and a liquid crystal layer 130 disposed between the lower substrate 110 and the upper substrate 120.

Although not shown in FIG. 1, the lower substrate 110 is a substrate on which thin film transistors and pixel electrodes are arranged in a matrix shape. The upper substrate 120 includes a color filter layer having color pixels for emitting predetermined colors when light passes therethrough, and a common electrode corresponding to the pixel electrodes.

The liquid crystal layer 130 has liquid crystal. In the present embodiment, the display apparatus 400 employs twisted nematic liquid crystal. Liquid crystal molecules are arranged in accordance with an electric field formed between the pixel electrodes and the common electrode.

The display apparatus 400 includes a first polarizing plate 210, a second polarizing plate 220 and a brightness enhancement film 230. The first polarizing plate 210 polarizes light supplied to the display panel 100. The first polarizing plate 210 is coupled to a surface of the lower substrate 110 via a first adhesive layer 240. The second polarizing plate 220 polarizes light having passed through the display panel 100. The second polarizing plate 220 is coupled to a surface of the upper substrate 120 via a second adhesive layer 250. The brightness enhancement film 230 is configured to enhance the brightness of the light supplied to the first polarizing plate 210. The brightness enhancement film 230 is coupled to the first polarizing plate 210 via a diffusing adhesive layer 260.

As shown in FIGS. 1 and 2, the diffusing adhesive layer 260 includes an adhesive material 261 and a plurality of diffusing particles 262. The brightness enhancement film 230 is coupled to the surface of the first polarizing plate 210 by means of the adhesive material 261. The diffusing particles 262 are added into the adhesive material 261 so as to diffuse the light passing through the brightness enhancement film 230. The light that is diffused by the diffusing particles 262 is then provided to the first polarizing plate 210.

In the present embodiment, the adhesive material 261 has a refractive index different from a refractive index of the diffusing particles 262. Thus, the light supplied to the diffusing adhesive layer 260 is refracted and diffused by the diffusing particles 262.

Referring to the FIG. 1, the display apparatus 400 includes a backlight assembly 300 having a lamp 310 that generates light and a light guide plate 320 that guides the light toward the display panel 100.

The light guide plate 320 has a generally rectangular shape and is disposed adjacent to the lamp 310 so as to receive the light through a side surface 321. The incident light is reflected from a lower surface 322 of the light guide plate 320 and passes through an upper surface 323 of the light guide plate 320 toward the display panel 100. The lower surface 322 of the light guide plate 320 is inclined with respect to the upper surface 323 such that a distance between the upper surface 323 and the lower surface 322 gradually decreases as the distance from the lamp 310 increases. Thus, there is an improvement of the uniformity of the brightness of the light coming out of the light guide plate 320 toward the display panel 100.

The backlight assembly 300 further includes a light diffusing sheet 330 disposed on the upper surface 323 of the light guide plate 320 and a light collimating sheet 360 disposed on the light diffusing sheet 330. The light diffusing sheet 330 diffuses the light having come out of the upper surface 323 of the light guide plate 320. The light collimating sheet 360 collimates the diffused light having passed through the light diffusing sheet 330.

The light collimating sheet 360 includes a first prism sheet 340 having first prism patterns 341 extended in a first direction D1, and a second prism sheet 350 having second prism patterns 351 extended in a second direction D2 that is different from the first direction D1. The first prism sheet 340 is disposed on the light diffusing sheet 330 so as to collimate the diffused light having passed through the light diffusing sheet 330. The second prism sheet 350 is disposed on the first prism sheet 340 so as to collimate the light having passed through the first prism sheet 340. In the present embodiment, the first prism patterns 341 are substantially perpendicular to the second prism patterns 351. Of course, in alternative embodiments the first and second prism pattern directions may not be perpendicular.

The diffusing adhesive layer 260 is configured to effectively reduce Moiré interference or a waviness appearance, thereby improving the display quality of the display apparatus 400. For example, by controlling a haze characteristic or value of the diffusing adhesive layer 260, the Moiré characteristic can be controlled. As illustrated in Table 1, the Moiré interference becomes weaker as the haze value becomes higher. For a haze value near 60%, the Moiré interference substantially weakens.

In experimental example 1, the diffusing adhesive layer 260 has a haze value of about 34%. In experimental example 2, the diffusing adhesive layer 260 has a haze value of about 45%. In experimental example 3, the diffusing adhesive layer 260 has a haze value of about 62%. In experimental example 4, the diffusing adhesive layer 260 has a haze value of about 80%. In addition, an adhesive (not shown) used in a comparative example has a haze value of about 0%. Table 1

| | Compar- | Experi- | Experi- | Experi- | Experi- |
|---|---|---|---|---|---|
| | ative | mental | mental | mental | mental |
| | example | example 1 | example 2 | example 3 | example 4 |
| Haze value | 0% | 34% | 45% | 62% | 80% |
| Moiré | Strong | Neutral | Neutral | Weak | None |
| Interference | | | | | |

As represented by table 1, the Moiré interference has strongly occurred in the case of the comparative example of which the adhesive has the haze value of 0%. In the experimental examples 1 and 2, in each of which the diffusing adhesive layer 260 has a haze value that is less than 60%, the Moiré interference that is slightly weaker than that of the comparative example has still occurred. In the case of experimental example 3 of which the diffusing adhesive layer 260 has the haze value of 62%, the Moiré interference has weakly occurred. In the experimental example 4, the diffusing adhesive layer 260 has the haze value of 80%, the Moiré interference has not occurred.

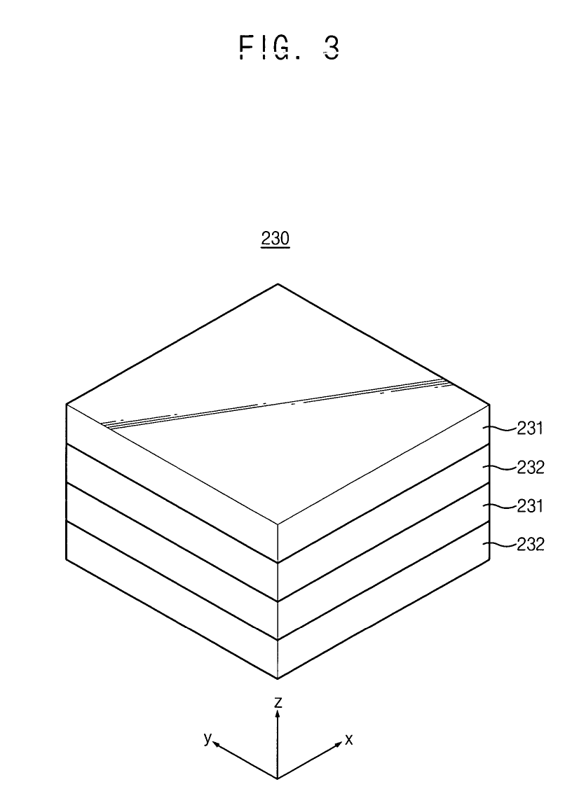

FIG. 3 is an expanded perspective view showing the brightness enhancement film shown in FIG. 1.

Referring to FIG. 3, the brightness enhancement film 230 comprises first layers 231 and second layers 232. The brightness enhancement film 230 is configured wherein the lower and upper surfaces of each of the first and second layers 231, 232 lie substantially in an x-y plane. A z-direction is oriented substantially perpendicular to the x-y plane or directions as shown in FIG. 3. The first layer 231 is configured to have a refractive-index anisotropy in the x-y plane. The second layer 232 is configured with no refractive-index anisotropy in the x-y plane. Accordingly, the brightness enhancement film 230 has an anisotropic characteristic where the transmittance and the refractive index are different depending on a polarizing state and a polarizing direction of the incident light.

For example, in case that the refractive index of the first layer 231 is the same as that of the second layer 232 with respect to the x and z-directions, while the refractive index of the first layer 231 is different from that of the second layer 232 with respect to the y-direction, and non-polarized light is incident into the brightness enhancement film 230 in the z-direction, x-directional polarizing components may pass through the brightness enhancement film 230, while y-directional polarizing components are reflected from the brightness enhancement film 230. This phenomena is according to Fresnel's equation Rₛ=[Sin (θi−θₜ)/Sin (θi−θₜ)]², and characteristic of birefringent materials. As an example of a birefringent dielectric multi-layer having the above characteristics, there is a dual brightness enhancement film (“DBEF”) made by 3M Co., Ltd.

The DBEF has a multi-layered structure including two thin films made of different materials alternately stacked in a plurality of layers. That is, a polyethylene naphthalate layer having a high birefringence index and a polymethyl methacrylate (“PMMA”) layer having an isotropic structure, where both layers are alternately stacked one upon another, thereby forming the DBEF. The PMMA includes a naphthalene radical having a planar structure, so the polyethylene naphthalate layer may be easily stacked. The refractive index in the stacking direction of the polyethylene naphthalate layer may be remarkably different from the refractive index in the other directions. On the contrary, the PMMA such as amorphous high-polymer, is isotropically aligned, so that the PMMA layer has the same refractive index for all directions.

As described above, the brightness enhancement film 230 transmits the x-directional polarizing components therethrough and reflects the y-directional polarizing components, and recycles the reflected light. That is, the brightness enhancement film 230 may transmit most of the incident light, thereby improving the brightness of the display apparatus 400. In the present embodiment, the x-direction is substantially parallel to a polarizing axis of the second polarizing plate 220 and the y-direction is substantially parallel to a polarizing axis of the first polarizing plate 210.

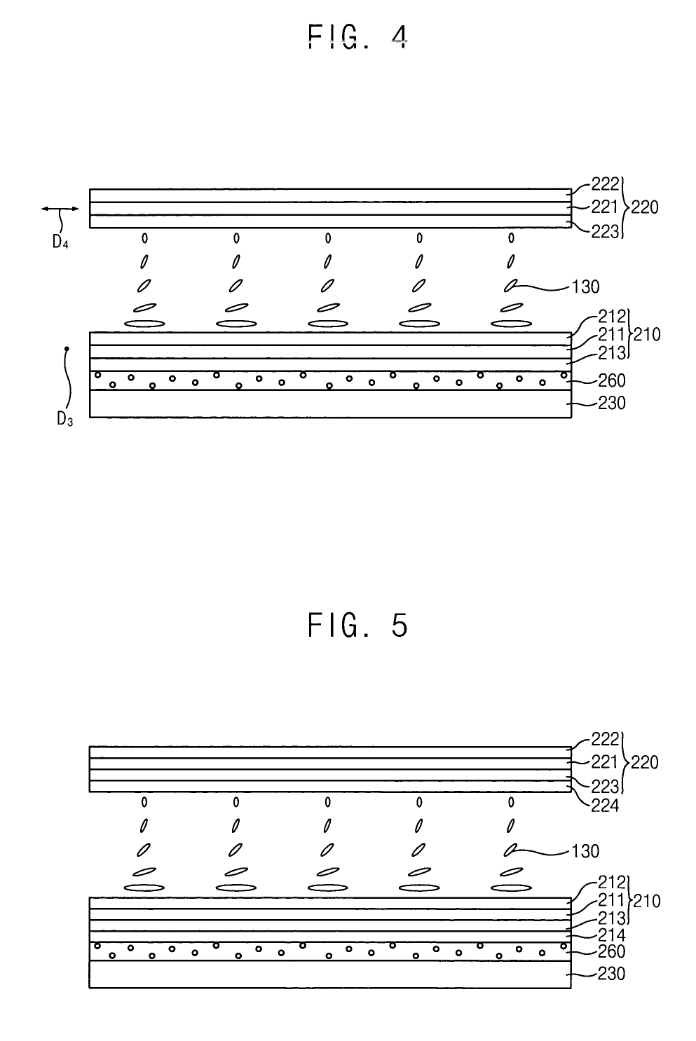

FIG. 4 is a cross-sectional view showing the first polarizing plate and the second polarizing plate shown in FIG. 1.

Referring to FIG. 4, the first polarizing plate 210 includes a first polarizing layer 211 to polarize the light, a first supporting layer 212 to support the first polarizing layer 211, and a second supporting layer 213 to support the first polarizing layer 211. In this embodiment, the first supporting layer 212 is disposed on an upper surface of first polarizing layer 211, while second supporting layer 213 is disposed along a lower surface of the first polarizing layer 211.

The first polarizing layer 211 is formed by applying iodine or dichromatic dyes into a polyvinyl alcohol (hereinafter, referred to as “PVA”) layer having a transmission axis that is extended in a third direction D3. The first polarizing layer 211 transmits light components oscillating in the third direction D3 and absorbs light components oscillating in a fourth direction D4 that is substantially perpendicular to the third direction D3, as illustrated in FIG. 4. The first and second supporting layers 212 and 213 are made of triacetate cellulose (hereinafter, referred to as “TAC”) resin and support both surfaces of the first polarizing layer 211.

The second polarizing plate 220 includes a second polarizing layer 221 configured to polarize the light, a third supporting layer 222 disposed at a first surface of the second polarizing layer 221, and a fourth supporting layer 223 disposed at a second surface of the second polarizing plate 221. In other words, the third supporting layer 222 is disposed on an upper surface of the second polarizing layer 221, while the fourth supporting layer 223 is disposed along a lower surface of the second polarizing layer 221. The third and fourth supporting layers 222 and 223 support the second polarizing layer 221.

The second polarizing layer 221 is formed by applying iodine or dichromatic dyes into the PVA layer having a transmission axis that is extended in a fourth direction D4, as illustrated in FIG. 4. The second polarizing layer 221 is configured to transmit light components oscillating in the fourth direction D4 and absorbs light components oscillating in the third direction D3. The third and fourth supporting layers 222 and 223 are made of TAC resin and support the first and second surfaces of the second polarizing layer 221. In the present embodiment, the second polarizing plate 220 is a polarizing plate hard-coated without a nti-glare. Particularly, the third supporting layer 222 may be hard-coated without anti-glare treatment.

The light having come out of the backlight assembly 300 is diffused by the diffusing adhesive layer 260 after passing through the brightness enhancement film 230. The diffused light is polarized by the first polarizing plate 210 such that only components of the light oscillating in the third direction D3 remain. The components of the light oscillating in the third direction D3 are changed by liquid crystal layer 130 having liquid crystal molecules aligned in a designated direction. Then those light components are polarized by the second polarizing plate 220 such that only components of the light oscillating in the fourth direction D4 remain. Thus, the transmittance of the light having come out of the backlight assembly 300 may be controlled, so that the display apparatus 400 may display images using the light from the backlight assembly 300.

In the present embodiment, the first polarizing plate 210, the display panel 100 and the second polarizing plate 220 sequentially receive the diffused light by the diffusing adhesive layer 260. Therefore, the display panel 100 may enhance the brightness uniformity of the light and effectively prevent Moiré interference of the display apparatus 400, thereby improving display quality of the display apparatus 400.

FIG. 5 is cross-sectional view showing a first polarizing plate and a second polarizing plate for the display apparatus according to another exemplary embodiment of the present invention. In FIG. 5, the same reference numerals denote the same elements in FIG. 4, and thus any further detailed descriptions of the same elements will be omitted.

Referring to FIG. 5, the display apparatus according to another exemplary embodiment of the present invention includes a first visual angle improving film 214 and a second visual angle improving film 224. In the present embodiment, each of the first and second visual angle improving films 214 and 224 is a retardation film configured to change phases of light. The first and second visual angle importing films 214 and 224 will be referred to, hereinafter, as first and second retardation films, respectively. The first retardation film 214 is disposed between the second supporting layer 213 and the diffusing adhesive layer 260 so as to enhance a visual angle of the light having passed through the diffusing adhesive layer 260. The second retardation film 224 is disposed under the fourth supporting layer 223 so as to enhance a visual angle of the light having passed through the liquid crystal layer 130.

Alternative embodiments include configurations where the first and second retardation films 214 and 224 may be integrally formed with or separately formed from the first and second polarizing plates 210 and 220, respectively.

The first and second retardation films 214 and 224 include twisted liquid crystal that is rubbed in a predetermined direction. In the present embodiment, the rubbing direction of the first retardation film 214 is substantially parallel to a transmission axis of the first polarizing plate 210, and the rubbing direction of the second retardation film 224 is substantially parallel to a transmission axis of the second polarizing plate 220.

The above described embodiments provide an improved display apparatus by effectively preventing the Moiré interference, thereby improving the display quality of the display apparatus 400.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation or quantity, but rather denote the presence of at least one of the referenced item.

What is claimed is:

1. A display apparatus comprising:
a backlight assembly to generate a light;
a brightness enhancement film disposed on the backlight assembly to enhance brightness of the light;
a display panel disposed on the brightness enhancement film to display images using the light; and
a diffusing adhesive layer having an adhesive material and light diffusing particles added into the adhesive material to diffuse the light passing through the brightness enhancement film.

2. The display apparatus of claim 1, wherein the diffusing adhesive layer is disposed between the display panel and the brightness enhancement film.

3. The display apparatus of claim 1, wherein the adhesive material has a refractive index different from a refractive index of the light diffusing particles.

4. The display apparatus of claim 1, wherein the diffusing adhesive layer has a haze value that is greater than or equal to 60%.

5. The display apparatus of claim 1, further comprising:
a first polarizing plate disposed under the display panel, the first polarizing plate being configured to polarize the light supplied to the display panel; and
a second polarizing plate disposed on the display panel, the second polarizing plate being configured to polarize the light passing through the display panel.

6. The display apparatus of claim 5, wherein the brightness enhancement film is coupled to the first polarizing plate via the diffusing adhesive layer.

7. The display apparatus of claim 5, further comprising:
a first adhesive layer disposed between the first polarizing plate and the display panel, the first adhesive layer coupling the first polarizing plate to a lower surface of the display panel; and
a second adhesive layer disposed between the second polarizing plate and the display panel, the second adhesive layer coupling the second polarizing plate to an upper surface of the display panel.

8. The display apparatus of claim 5, further comprising:
a first visual angle improving film disposed between the first polarizing plate and the diffusing adhesive layer, the first visual angle improving film being configured to improve a visual angle of the light passing through the first polarizing plate; and
a second visual angle improving film disposed between the second polarizing plate and the display panel, the second visual angle improving film being configured to improve a visual angle of the light passing through the display panel.

9. The display apparatus of claim 8, wherein each of the first and second visual angle improving films is a retardation film.

10. The display apparatus of claim 9, wherein the retardation film is configured to change a phase of light passing therethrough.

11. The display apparatus of claim 8, wherein the first visual angle improving film includes twisted liquid crystal rubbed in a first direction, and the second visual angle improving film includes twisted liquid crystal rubbed in a second direction.

12. The display apparatus of claim 11, wherein the first direction is substantially parallel to a transmission axis of the first polarizing plate, and the second direction is substantially parallel to a transmission axis of the second polarizing plate.

13. The display apparatus of claim 5, wherein the first polarizing plate includes:
a polarizing layer configured to polarize light passing through the diffusing adhesive layer;
a first supporting layer disposed between the polarizing layer and the diffusing adhesive layer; and
a second supporting layer disposed between the polarizing layer and the liquid crystal layer.

14. The display apparatus of claim 13, further including a visual angle improving film disposed between the first supporting layer and the diffusing adhesive layer.

15. The display apparatus of claim 5, wherein the second polarizing plate include:
a polarizing layer configured to polarize light passing through the liquid crystal layer;
a first supporting layer disposed between the polarizing layer and the liquid crystal layer; and
a second supporting layer disposed on the polarizing layer at a side opposite to a side at which the first supporting layer is disposed.

16. The display apparatus of claim 15, further including a visual angle improving film disposed between the first supporting layer and the liquid crystal layer.

17. The display apparatus of claim 1, wherein the backlight assembly comprises:
a lamp to generate the light;
a light guide plate to guide the light from the lamp toward the display panel;
a light diffusing sheet to diffuse the light provided from the light guide plate; and
a light collimating sheet to collimate the light passing through the light diffusing sheet.

18. The display apparatus of claim 17, wherein the light collimating sheet comprises:
a first prism sheet disposed on the light diffusing sheet, the first prism sheet being configured to collimate the light passing through the light diffusing sheet, the first prism sheet having first prism patterns extending in a first direction; and
a second prism sheet disposed on the first prism sheet, the second prism sheet being configured to collimate a light passing through the first prism sheet, the second prism sheet having second prism patterns extending in a second direction different from the first direction.

19. The display apparatus of claim 18, wherein the first prism patterns are substantially perpendicular to the second prism patterns.

20. A display apparatus comprising:
a backlight assembly to generate a light;
a display panel having a lower substrate, an upper substrate facing the lower substrate and a liquid crystal layer between the lower substrate and the upper substrate to display images using the light;
a first polarizing plate disposed under the display panel to polarize the light provided from the backlight assembly;
a second polarizing plate disposed on the display panel to polarize the light passing through the display panel;
a brightness enhancement film disposed between the first polarizing plate and the backlight assembly to enhance brightness of the light supplied to the first polarizing plate from the backlight assembly; and
a diffusing adhesive layer having an adhesive material to couple the brightness enhancement film onto a surface of the first polarizing plate and diffusing particles added into the adhesive material to diffuse the light passing through the brightness enhancement film.

21. The display apparatus of claim 20, wherein the adhesive material has a refractive index different from a refractive index of the diffusing particles.
